(19) United States
(12) Patent Application Publication
(10) Pub. No.: US 2009/0106101 A1
(43) Pub. Date: Apr. 23, 2009

(54) Public transportation usage tracking method and apparatus

(76) Inventor: Kim R. Green, Schaumburg, IL (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/976,002

(22) Filed: Oct. 19, 2007

(51) Int. Cl. G06Q 99/00

(52) U.S. Cl. 705/14; 705/1

(57) ABSTRACT

A method of tracking usage of a public transportation system for calculating a benefit for using public transportation includes: collecting trip data about a specific user and a specific trip on a public transportation system; and compiling trip data for the user and providing it to at least one of the following: the user and an entity interested in tracking the usage. A system for tracking a user's use of public transportation includes: a portable storage medium; a reading device for reading trip information from the portable storage medium the portable storage medium associated with a public transpiration system; a central data storage operatively connected to several reading devices for storing trip information read by the reading device; a data compiler configured to compile the trip information and generate a report of trip information and amount of credits entitled to a user; and an interface with the data complier configured to make available the report to at least one of the following two entities: the user to which the trip data pertains and an entity.

### FIELD OF THE INVENTION

The present invention relates generally to a system and apparatus for tracking usage of a public transportation system. More particularly, the present invention relates to a method and apparatus for tracking the amount of usage of a public transportation system providing a report of that usage so that a system patron can obtain a government benefit based on usage of the public transportation system.

### BACKGROUND OF THE INVENTION

Sources of energy such as fossil fuels are becoming increasingly more expensive. Once reason for this is that the demand is continuing to increase while the supplies have not kept up with demand and in some instances may becoming less plentiful. Another problem with fossil fuels is the amount of carbon and other undesirable substances that are vented into the environment during combustion of fossil fuels.

One large use of fossil fuel is for people to commute to work and back each day in their vehicles. In addition to using large amounts of fossil fuels, commuting also creates a problem of overwhelming local roads with traffic during certain times of the day. In order to make commuting easier, and reduce the use of fossil fuels many governments have, at great expense, built public transportation systems which may include busses, light rail, subways, metro systems, commuter trains, van pools, car pools, ferries, and other types of transportation systems in order to ease congestion and conserve the use of fossil fuels.

In many instances the public transportation systems are under utilized and have the capacity to carry more commuters than those currently using the system. Thus, in order to reduce the use of fossil fuels and the associated pollution and to reduce congestion, governments may be interested in providing incentives for people to commute via public transportation systems rather than private vehicles.

Accordingly, it is desirable to provide a method and apparatus that may include rewarding users of public transportation based on ridership. According, it is desirable to provide a method and apparatus that tracks ridership on a public transportation system so that the ridership data can be used in providing a government incentive.

### SUMMARY OF THE INVENTION

The foregoing needs are met, to a great extent, by the present invention, wherein in one aspect an apparatus and method is provided that in some embodiments ridership of a public transportation is tracked and data compiled so that the compiled data is used in calculating how much of a benefit a user is entitled to. The benefits are used as an incentive to continuing to use public transportation systems.

In accordance with one embodiment of the present invention, a method of tracking usage of a public transportation system for calculating a benefit for using public transportation is provided. In some embodiments of the invention, the method includes collecting trip data about a user and a trip taken by the user on a public transportation system, compiling trip data of the user based on the user's usage of the public transportation system, determining whether the user has earned the benefit based on the trip data, and providing the trip data and information on whether the user has earned the benefit to at least one of the following: the user and a government entity.

In accordance with another embodiment of the present invention, a system for tracking a user's use of public transportation is provided. In some embodiments of the invention, the system includes a portable storage medium that the user uses in order to use the public transportation system, a reading device that reads trip information from the portable storage medium of the user, a remote central data storage operatively connected to several reading devices for storing trip information read by the reading device, a data compiler configured to compile the trip information of the user and generates a report of the trip information and amount of credits entitled to the user, and an interface with the data complier configured to make available the report to at least one of the following two entities: the user to which the trip data pertains and a government entity.

In accordance with yet another embodiment of the present invention, a method of tracking usage of a public transportation system for calculating a benefit for using public transportation is provided. In some embodiments of the invention, the method includes obtaining trip information of a user by interacting with a trip information recording system that is located in the public transportation system, sending the trip information on a remote data storage device, receiving the trip information and whether a governmental benefit is due to the user that is sent by the remote data storage device, and obtaining the government benefit based on the trip information.

In accordance with still another embodiment of the present invention, a method of tracking usage of a public transportation system for calculating a benefit for using public transportation is provided. In some embodiments of the invention, the method includes collecting trip data about a user and a trip taken by the user on a public transportation system, compiling trip data of the user based on the user's usage of the public transportation system, determining whether the user has earned the benefit based on the trip data, and providing the trip data and information on whether the user has earned the benefit to at least one of the following: the user and an entity other than a governmental entity interested in tracking the trip data of the user.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a flow chart illustrating the steps that may be followed in a method in accordance with the invention.

FIG. 2 is a schematic diagram representing a public transportation ridership tracking system in accordance with an embodiment of the invention.

FIG. 3 is a schematic diagram of a system that tracks ridership of a public transportation system in accordance with another embodiment of the invention.

### DETAILED DESCRIPTION

The invention will now be described with reference to the drawing figures, in which like reference numerals refer to like parts throughout. An embodiment in accordance with the present invention provides a method and a system for tracking a user's use of a public transportation system that includes compiling the data regarding the user's use of the transportation system and preparing a report of that use of the public transportation system and providing that report to one or both of the user and a government entity so that the compiled data can be used in calculating a government benefit.

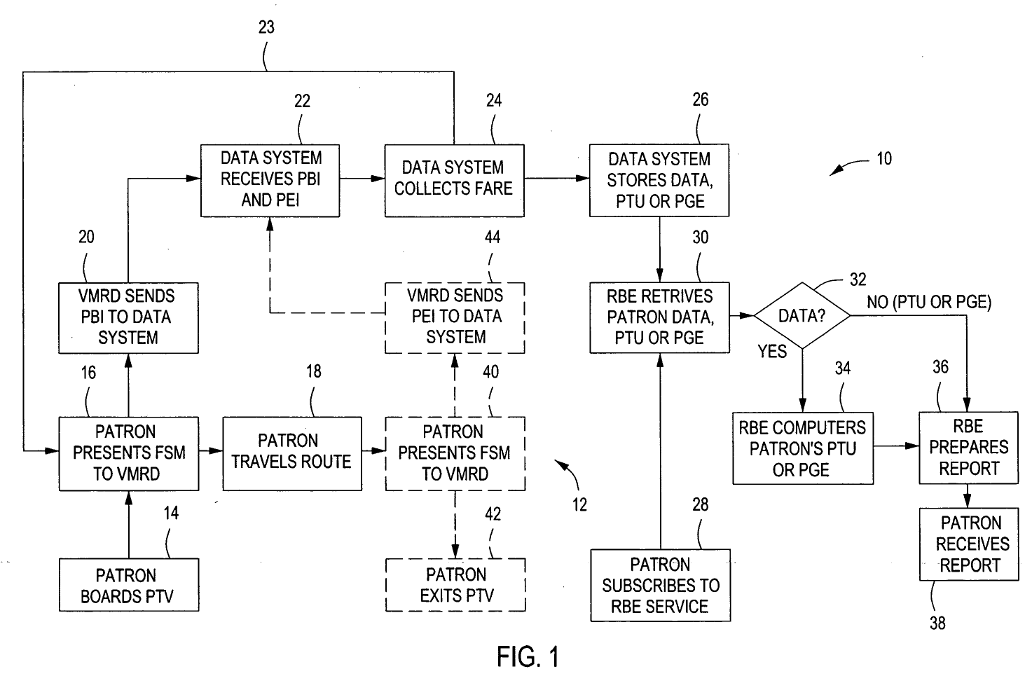

An embodiment of the present inventive method of tracking 10 is illustrated in FIG. 1. One embodiment of the invention is illustrated in the flow chart using solid lines. A second embodiment which includes the steps outline in the first embodiment and extra steps is also illustrated. The extra steps are shown in broken lines in FIG. 1.

In the first step 14 of the method 10, a user also referred to as a patron or user enters a public transportation system. In some embodiments of the invention, entering the public transportation system can include boarding a public transportation vehicle (PTV) such as a bus, a train, a van of a van pool, ferry or other vehicle. In other embodiments of the invention, entering the public transportation system can include entering a train station or a bus station or any other type of station for a public transportation vehicle.

In the next step 16, the user or patron presents a fare storage medium (FSM) to a vehicle medium reading device (VMRD). The FSM may be a device that stores an amount of fare such as those currently used by public transportation systems, that may include a coded magnetic card, a credit card, an RFID, a SmartCard or any other small portable device that can store data.

In some embodiments of the invention, the FSM stores fare information and presenting the FSM to the VMRD is how the patron pays the fare for the public transportation system.

In other embodiments of the invention, the fare is not paid at this time but rather the system notes where the patron gets on and the actual fare will be deducted when the patron leaves the system or at some other time.

In accordance with an embodiment of the invention, the VMRD interacts with the FSM and notes where and when the patron gets on the public transportation system. The FSM interacts with the VMRD to exchange data. In some embodiments of the invention, the trip data that is exchange can include a patron boarding information (PBI) such as the identification of a user, the date, time, and boarding location or GPS coordinates of the location of the user/patron when entering the public transportation system.

In other embodiments of the invention, other information can also be exchanged such as common identifying information such as a particular company employing the users and who is tracking the transportation of its employees to receive a benefit for a number of its employees using the public transportation system. Identifying data associated with the company can also be exchanged between the FSM and the VMRD when the patron presents the FSM to the VMRD.

The user/patron in step 18, travels on the public transportation system. The VMRD in the next step 20 sends the PBI to the data system where the PBI can be stored and/or processed. In step 22, the data system receives the PBI and in step 24, an optional embodiment of the invention, the system will collect a fare associated with the PBI. Optionally, after step 24, the method can proceed back to step 16 via step 23.

In the next step 26, the data system stores the data such as the PBI. PBI can be processed and characterized as a public transportation usage or pattern of usage (PTU). The PBI can also be processed to associate a particular amount of benefit or how much usage has occurred and link it to an amount of an entitlement a user is entitled to because of the public transportation usage (PTU). The PTU can be stored at step 26.

The patron boarding information can be monitored over time and then compiled indicating an amount of times or distance traveled by a particular user such as over several months or a year or any selected time period. Once a selected time period has been established, an amount of miles or trips or some other useful metric used for establishing ridership on a public transportation system has been complied, it may be associated with an amount of a government entitlement the user is eligible for. The amount of entitlement the user is eligible for may be referred to as a patron's green entitlement (PGE). Potential PGE's can include tax credit, tax deduction amounts, and carbon credits than can be credited to the user for the user's usage of the public transportation system. The PGE can be stored at step 26.

In some embodiments of the invention, the next step 30 is for the date such as BTI, PTU or the PGE to be reported to a reporting business entity (RBE). In some embodiments of the invention, the RBE may be the entity that is operating the transportation system such as a government entity (federal, state, county, city or local). In other embodiments of the invention, the RBE may be some other entity such as a contractor that is operating a fare collection system or other system within the public transportation system.

In some embodiments of the invention, there is an optional step, step 28 where the patron or user can subscribe to a service provided by the RBE. The service may permit the user/patron to access the ridership data such as the BTI, PTU or PGE. In some embodiments of the invention, the patron can select the time frame for which the patron wants to see how many trips or how long the patron has traveled on the public transportation, or how many government benefits such as tax credits, carbon credits or tax deduction the patron is eligible for or has qualified for, for the patron's selected time period.

In the next step 32, the system analyzes the data and determines whether or not there has been any public transportation usage (PTU) or an entitlement (PGE) earned. In the next step, step 34, the RBE computes a patron's PTU or PGE. Once the public transportation usage or patron's green entitlements earned has been computed, the RBE can prepare a report in step 36 that is made available to the patron. The report may be available via the internet, email, fax, over the phone, or be sent to the patron through the mail. In other embodiments of the invention, the report is sent directly to a government entity such as the Internal Revenue Service. The reports may also be sent to local or state tax agencies. In other embodiments of the invention, the report may be sent to other government entities that will provide benefits to the patron.

In step 38 the patron receives the report. If there has been no PTU or PGE, the RBE may prepare a report indicating the non usage and no entitlements earned to government entity or to the patron.

In optional embodiments of the invention, additional steps are used to track a user's usage of a public transportation system. The extra steps 12 are indicated in FIG. 1 in broken lines. After the patron has presented the FSM to the VMRD in step 16, the patron will travel the route as in step 18. At the end of the route, the patron will again present the FSM to a VMRD at step 40. The patron will exit the public transportation vehicle or public transportation system in step 42. At step 40, this is the second time the patron has presented the FSM to the VMRD. The VMRD will record patron exit information (PEI) such as the patron ID, the time, the date and the exiting location or the GPS or other location indicators of where the user/patron exited the public transportation system. The vehicle medium reading device (VMRD) will send the patron exit information (PEI) to the data system, in step 44.

Thus, in some embodiments of the invention, the data system receives both patron boarding information and patron exit information and is able to make report, a more detailed report, of the patron's usage of the public transportation system. Thus, when a report is generated, such as in step 36, the report can reflect where the patron got on the public transportation and where the patron got off of the public transportation. Thus, in such embodiments of the invention, the patron's green entitlements can be based on where a patron got a public transportation system and where a patron exited a public transportation data system.

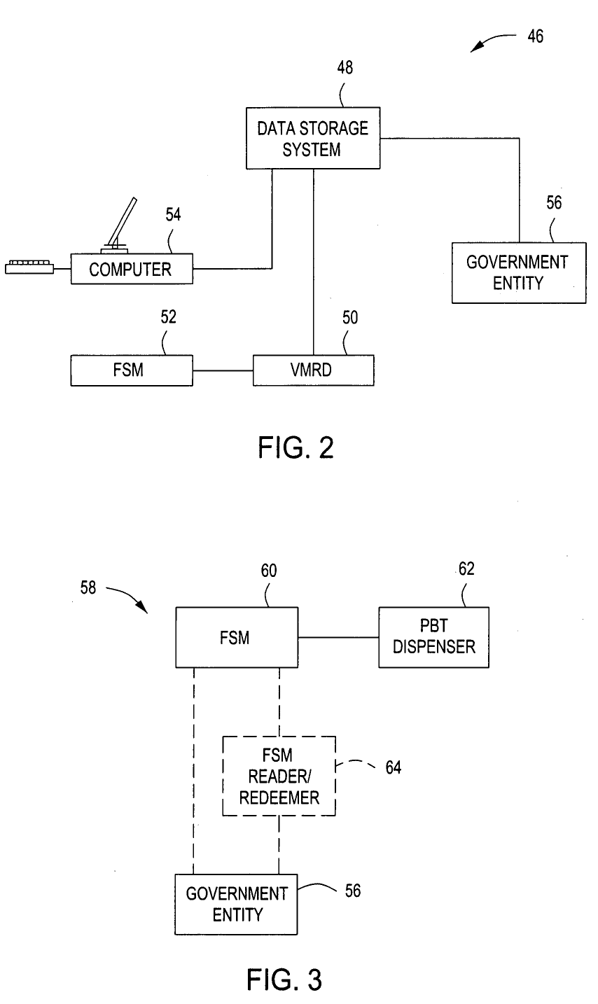

Turning now to FIG. 2, a system for monitoring and reporting a user or patron's usage of a public transportation system 46 is illustrated. In some embodiments of the invention, the monitoring reporting system 46 includes a data storage system 48. The storage system 48 can include microprocessors and a data base for storing information such as the patron boarding information (PBI), patron exiting information (PEI), and computer programs and code for associating public transportation usage with certain government benefits and entitlements such as patron's green entitlement (PGE).

In some embodiments of the invention, the patron can board a public transportation system and present a storage medium such as a coded magnetic card, credit card, smartcard, or RFID. In this document the storage medium may be referred to as a fare storage medium or (FSM) 52. The FSM can electronically communicate and exchange information with the vehicle medium reading device VMRD 50. The VMRD 50 transmits the data received from FSM to the data storage system 48.

In some embodiments of the invention, the FSM 52 may be presented in exchange with the VMRD 50 when a patron or user boards a public transportation system. In other embodiments of the invention, the FSM will be presented twice, once when the patron boards and once when the patron exits the public transportation system. In embodiments where the patron presents the FSM only one time to a VMRD 50, the data storage systems 48 may record how many trips a particular patron or user will take on the public transportation system and in some embodiments of the invention, it may assign a particular or predetermined value in terms of green entitlements for each trip. In embodiments of the invention where the patron or user presents the FSM 52 at boarding and exiting a public transportation system to the VMRD 50, the data storage system 48 can store information including when a patron entered the public transportation system and when the patron exited the public transportation system and calculate the patron's green entitlements accordingly.

In some embodiments of the invention, the data storage system 48 will compute and provide reports regarding ridership of a patron of a public transportation systems and the reports may include how many green entitlements a patron has accumulated. These reports can be available to the patron for the patron to review and dispute if necessary.

In some embodiments of the invention, the patron may log onto the data storage system via the internet using a computer 54.

In other embodiments of the invention, the reports and data may be available to a patron via mail, email, fax, telephone, or any other suitable mode. In some embodiments of the invention, the system 46 will provide ridership data and amount of green entitlements a user has qualified for to a government entity 56. These reports and data may be made available to the government entity 56 via the internet, email, telephone, mail or any other suitable way to convey the data to government entity 56.

Turning now to FIG. 3 another embodiment of the invention is illustrated. In the embodiment illustrated in FIG. 3, the FSM 60 stores data associated with the patron riding a public transportation system such as the data described above, including but not limited to, the patron's ID, the date and time of ridership boarding GPS location and in some embodiments of the invention, the system may store patron exit information such as that described above, for example, not limited to patron exiting date, time and location and distance traveled between the boarding location and the exiting location.

The FSM will communicate with a ridership data dispenser 62. The ridership data dispenser 62 can communicate with the FSM 60 and input information to the FSM 60 such as when a user boarded a transportation system and exited a transportation system, the patron ID, date and time of usage of a public transportation system. Thus, what could be stored on the FSM 60 is how much usage of a public transportation system a user has used.

Then according to the system 58 as shown in FIG. 3, the FSM 60 that has all the ridership data on it can have that data transferred to a government entity 56. It can be sent directly to the government entity or via e-mail, the internet, regular mail, or any other suitable method of transmitting information to the government entity where the data can be recognized by the government entity and converted into a patron's green entitlements.

The government entity 56 may include the IRS, state, country, city, local or any other government entity that can provide an entitlement to the user. Alternately, the FSM 60 can interact with an FSM reader redeemer 64 where the data can be read from the FSM to the FSM reader redeemer 64. The data may be characterized and complied into a report which is then sent to the government entity 56 so that the patron or user can receive the green entitlements for usage of the public transportation system.

Although the benefits system disclosed herein relate to receiving a benefit from a governmental entity, the invention can be used by other entities such as the employer of the user, a radio station, a website, a credit card company, an environmental group, a gas (natural or synthetic gas or oil based gasoline) a foreign country, a public transportation system provider (including the manufactures of the system), a corporation (such as ones that like to promote decrease emissions), volunteer emissions control programs such as the Chicago Climate Exchange and similar organizations or any entity that would like to encourage or promote the use of the public transportation system. The benefits offered by these entities can include, but no limited to, cash, trips, discounts, gifts, services, credits, tickets (movies, concerts, shows, etc.), days off, food or drinks and other benefits that a user would enjoy receiving.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method of tracking usage of a public transportation system for calculating a benefit for using public transportation comprising:
collecting trip data about a user and a trip taken by the user on a public transportation system;
compiling trip data of the user based on the user's usage of the public transportation system;
determining whether the user has earned the benefit based on the trip data;
providing the trip data and information on whether the user has earned the benefit to at least one of the following: the user and a government entity.

2. The method of claim 1, further comprising making the trip data and information available to the user via at least one of the following way: via the internet, email, fax, telephone, and mail.

3. The method of claim 1, wherein the government entity includes at least one of the following: federal, state, county, city and local tax authority.

4. The method of claim 1, further comprising associating trip data for a number of users having a common association and providing the associated trip data to a third party associated with the common association.

5. The method of claim 4, wherein the common association is an employer employing all of the number of users.

6. The method of claim 1, further comprising characterizing the trip data in terms of at least one of the following parameters: miles traveled, time saved, trips made, fuel saved, carbons used, and carbons saved.

7. The method of claim 1, further comprising collecting a fare from the user with at least some of the same portion of the system used to collect the trip data.

8. The method of claim 1, further comprising recording the trip data in at least one of the following places: a portable storage medium and a central storage device.

9. The method of claim 1, wherein the collecting trip data comprises:
communicating with a user storage medium via a transportation reading device;
sending user boarding information to a data storage device, wherein the compiling trip data comprises: preparing a trip data report that includes benefits in the form of credits earned by the user; and
sending the trip data report to the user.

10. The method of claim 9, wherein the user storage medium includes any one of the following: a coded magnetic card, a credit card, a smart card, and a RFID.

11. The method of claim 1, wherein the trip data includes any one or more of the following: a user's identification, date of trip, time of trip, and a boarding location.

12. The method of claim 9, wherein the credits earned include any one or more of the following: carbon credits and tax credits.

13. The method of claim 1, wherein collecting trip data comprises communicating with a user storage medium with a transportation reading when a user uses the public transportation system at a first location and at a second location when the user ends the use of the public transportation system; and
storing the trip data on a remote data storage system.

14. The method of claim 13, wherein the trip data includes any one or more of the following: a user's identification, date of trip, time of trip, the initial location and the ending location.

15. A system for tracking a user's use of public transportation system comprising:
a portable storage medium that the user uses in order to use the public transportation system;
a reading device that reads trip information from the portable storage medium of the user;
a remote central data storage operatively connected to several reading devices for storing trip information read by the reading device;
a data compiler configured to compile the trip information of the user and generates a report of the trip information and amount of credits entitled to the user; and
an interface with the data complier configured to make available the report to at least one of the following two entities: the user to which the trip data pertains and a government entity.

16. The system of claim 15, wherein the amount of credits entitled to the user is expressed in the report as at least one of the following: an amount of carbons saved by the user for using public transportation, an amount of carbons used by the user by using public transportation, an amount of fuel saved by the user by using public transportation rather than some other mode of travel.

17. The system of claim 15, wherein the trip information includes at least one of the following categories of information: number of trips taken by the user on the public transportation system in a defined time period, distance traveled by the user on the public transportation system, dates of travel by the user on the public transportation system, and time traveling on the public transportation system.

18. The system of claim 15, wherein the interface is the internet.

19. A method of tracking usage of a public transportation system by a user for calculating a benefit for using public transportation system, comprising:
obtaining trip information of a user by interacting with a trip information recording system that is located in the public transportation system;
sending the trip information on a remote data storage device;
receiving the trip information and whether a governmental benefit is due to the user that is sent by the remote data storage device; and
obtaining the government benefit based on the trip information.

20. The method of claim 19, wherein the government benefit is at least one of the following: a tax credit and tax deduction.

21. The method of claim 19, wherein the trip information includes at least two of the following categories of information: a user identification, an amount of carbon credits associated with a trip ridden by the user; distance traveled on the public transportation system; where the user boarded the public transportation system; and where the user exited the public transportation system.

22. The method of claim 19 further comprising:
determining whether the user earned the government benefit based on the trip information.

23. A method of tracking usage of a public transportation system for calculating a benefit for using public transportation comprising:
collecting trip data about a user and a trip taken by the user on a public transportation system;
compiling trip data of the user based on the user's usage of the public transportation system;
determining whether the user has earned the benefit based on the trip data;
providing the trip data and information on whether the user has earned the benefit to at least one of the following: the user and an entity other than a governmental entity interested in tracking the trip data of the user.

24. The method of claim 23, wherein the benefit is one of any of the following: cash, trips, discounts, gifts, services, credits, tickets, days off, food and drinks.

25. The method of claim 23, wherein the entity is one of any of the following: an employer of the user, a radio station, a web site, a gas company, a credit card company, an environmental group, a foreign country, a public transportation system provider, a corporation, volunteer emissions control programs or any entity that would like to encourage or promote the use of the public transportation system.
